(19) United States
(12) Patent Application Publication
(10) Pub. No.: US 2019/0061710 A1
(43) Pub. Date: Feb. 28, 2019

(54) PARKING BRAKE DEVICE

(71) Applicant: HONDA MOTOR CO., LTD., Tokyo (JP)

(72) Inventor: Fumikage YAMANAKA, Wako-shi (JP)

(21) Appl. No.: 16/114,652

(22) Filed: Aug. 28, 2018

(30) Foreign Application Priority Data
Aug. 30, 2017 (JP) 2017-164920

(51) Int. Cl. B60T 7/10

(52) U.S. Cl. CPC B60T 7/105

(57) ABSTRACT

A parking brake device is provided which includes a rigid base with a high manufacturing yield. A base for a braking unit of this parking brake device includes: a structural material having: a structural main body that supports a parking lever; and a plurality of leg portions that extend from the structural main body, an end of each leg portion being fixed to a vehicle body, wherein at least one (rear-side leg portion) of the leg portions is folded over and faces the structural main body so as to produce a shape to be installed onto the vehicle body.

### CROSS REFERENCE TO RELATED APPLICATION

The present application is based on Japanese application JP 2017-164920 filed on Aug. 30, 2017, the content of which is hereby incorporated by reference into this application.

### BACKGROUND OF THE INVENTION

### 1. Field of the Invention

The present invention relates to a parking brake device configured to generate braking force by a manual operation.

### 2. Description of the Related Art

Parking brake devices can generate braking force by manually moving a parking lever up and down so as to keep a vehicle in a parking state. The devices each include a base that swingably supports the parking lever. To date, the bases with different structures have been disclosed.

For instance, Japanese Patent Application Publication No. 2014-213696 discloses a base including: a pair of plate materials arranged face-to-face; and a reinforcing member sandwiched therebetween. Such a configuration makes it possible to make each plate material thinner, while giving the base high rigidity as well as reducing the weight of the base.

### SUMMARY OF THE INVENTION

An aspect of the present invention provides a parking brake device including a rigid base with a high manufacturing yield.

An aspect of the present invention provides a structural material including:
a structural main body that supports a parking lever; and
a plurality of leg portions that extend from the structural main body, an end of each leg portion being fixed to a vehicle body,

wherein at least one of the leg portions includes a folded region and a folded over region that faces the structural main body.

### BRIEF DESCRIPTION OF THE DRAWINGS

FIG. 1 is a side view of a braking unit of a parking brake device according to an embodiment of the present invention.

FIG. 2 is a schematic diagram of a base in FIG. 1.

FIG. 3 is a rear view of the base in FIG. 1.

FIG. 4 schematically illustrates a parent material from which patterned structural materials are punched out.

FIG. 5 is a perspective view illustrating how to process the shape of a structural material punched out.

FIG. 6 is a rear side view of a base according to a first embodiment.

FIG. 7 is a rear view of a base according to a second embodiment.

FIG. 8 is a rear view of a base according to a third embodiment.

FIG. 9 is a rear view of a comparative example of a base.

### DETAILED DESCRIPTION OF THE INVENTION

Prior to describing embodiments of the present invention, the above-mentioned related art will be further argued.

In the parking brake disclosed in Japanese Patent Application Publication No. 2014-213696, the reinforcing member sandwiched between the pair of plate materials may be formed of a plurality of parts. In this case, the rigidity of the base decreases because there are joint portions between the parts. Thus, the reinforcing member should be configured with one part.

However, if the reinforcing member is configured with one part, the shape of the reinforcing member has to fit to the shape of each plate material. Unfortunately, depending on the shape, this causes a manufacturing yield to deteriorate.

An aspect of the present invention provides a parking brake device including a rigid base with a high manufacturing yield.

### First Embodiment

A first embodiment of the present invention is described below in detail with reference to the Drawings. Note that in the description, the same elements have the same reference numerals so as to avoid redundancy.

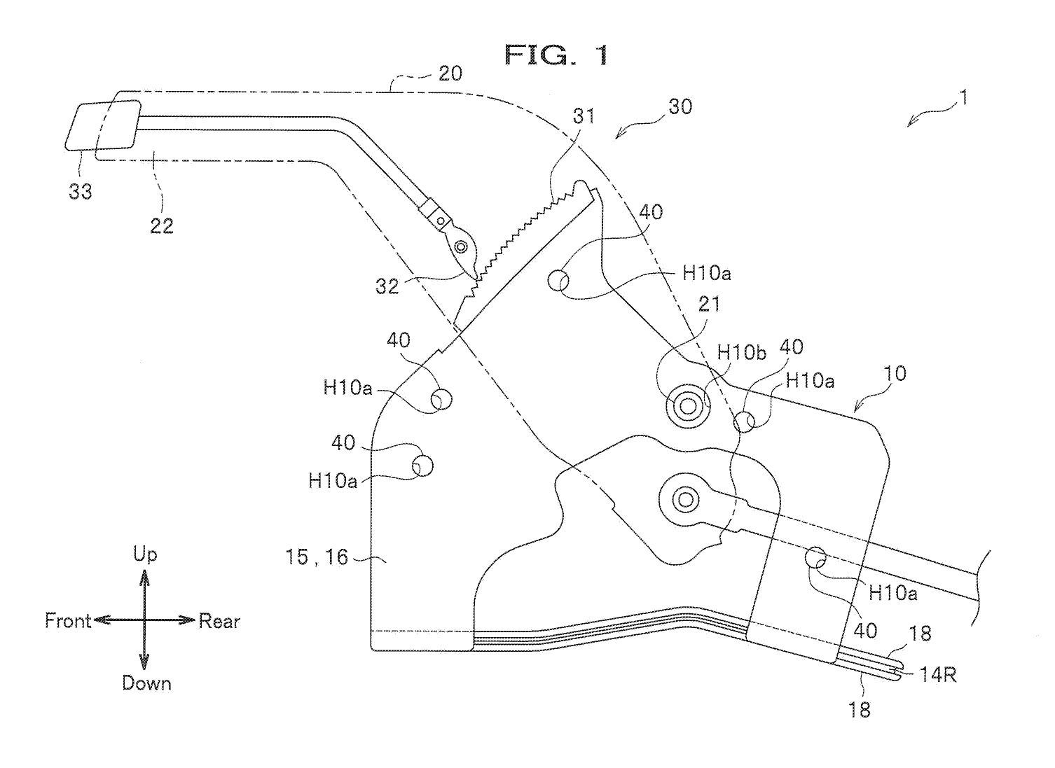

As shown in FIG. 1, a parking brake device 1 according to an embodiment of the present invention includes a base 10, a parking lever 20, and a ratchet mechanism 30. Meanwhile, this parking brake device 1 is installed, as a braking operation unit, on a floor tunnel (not shown) positioned between a driver's seat and a passenger seat.

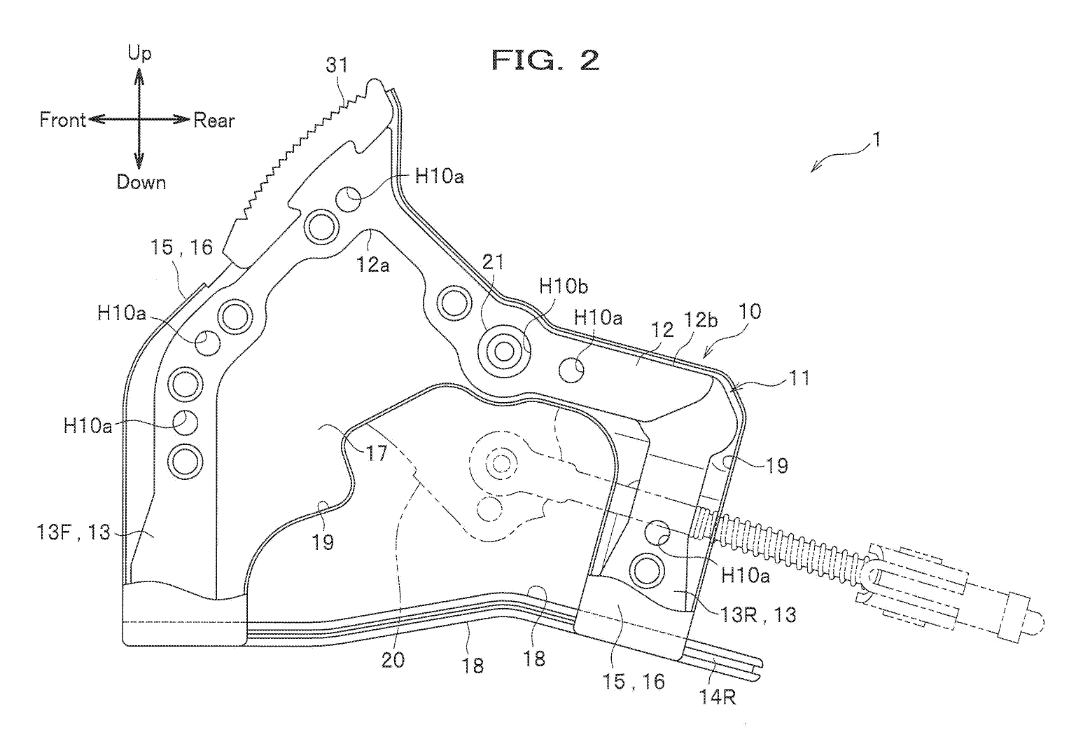

As shown in FIGS. 1 to 3, the base 10 is a part fixed to the floor tunnel; and the base 10 swingably supports the parking lever 20 such that the parking lever can be moved in up and down directions along a vertical plane between the driver's seat and the passenger seat. The base 10 is also provided with a structural material (a structural plate material) 11 and a case 15 for the base.

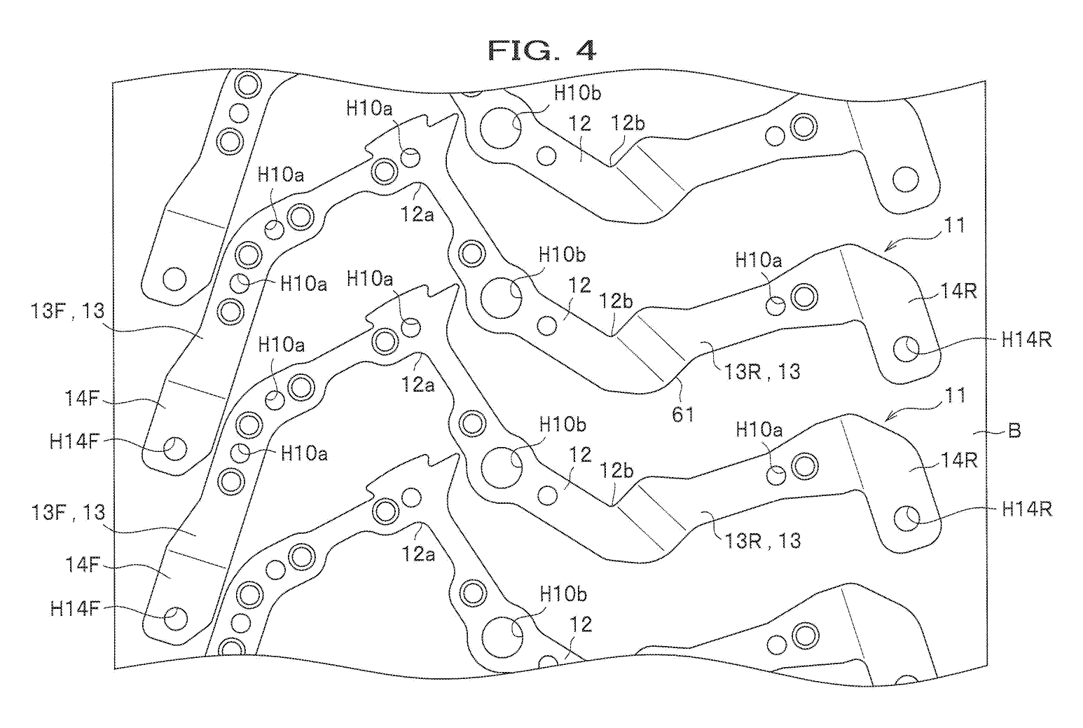

The case 15 houses the structural material 11 as a member for reinforcing the base 10. Here, the structural material 11 includes a main body 12 and a pair of leg portions 13. Then, as shown in FIG. 4, the structural material 11 is made of a member that is punched out from a long plate-like parent material B and has a predetermined shape.

The structural main body 12 is arranged such that a plate surface thereof is vertical to a vehicle width direction and extends in a vehicle longitudinal direction. In addition, a center portion of the structural main body 12 in the vehicle front-rear direction has a support hole H10b that is opened in a plate thickness direction (in the vehicle width direction).

The support hole H10b is an opening facing through holes of the structural main body 12 and the case 15 in assembled positions (coaxially disposed). Then, a support shaft 21 that rotatably supports the parking lever 20 is inserted through the support hole H10b.

The pair of leg portions 13 include a front-side leg portion 13F and a rear-side leg portion 13R.

The front-side leg portion 13F is a portion that supports a front side of the structural main body 12 onto a vehicle body and extends, like a substantial L-shape, downwardly from a front lower edge 12a of the structural main body 12. Then, the front-side leg portion 13F has, as a vehicle body fixture, a front-side fixing piece 14F at an end portion thereof.

The front side fixing piece 14F is bent toward the vehicle width direction such that a plate surface of the front side leg portion 13F is in contact with the upper surface of the floor tunnel, and has a front-side fixing hole H14F.

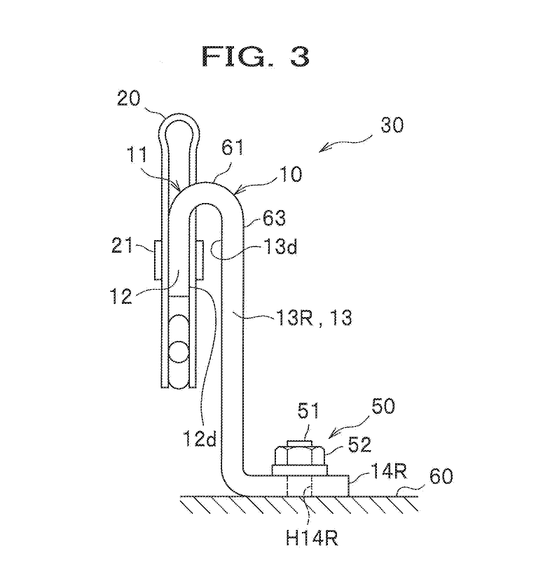

A bolt 51, a fastening means, is inserted through the front-side fixing hole H14F and a nut 52 is screwed on the bolt 51. In this way, the front-side leg portion 13F is fixed to the vehicle body (see FIG. 3).

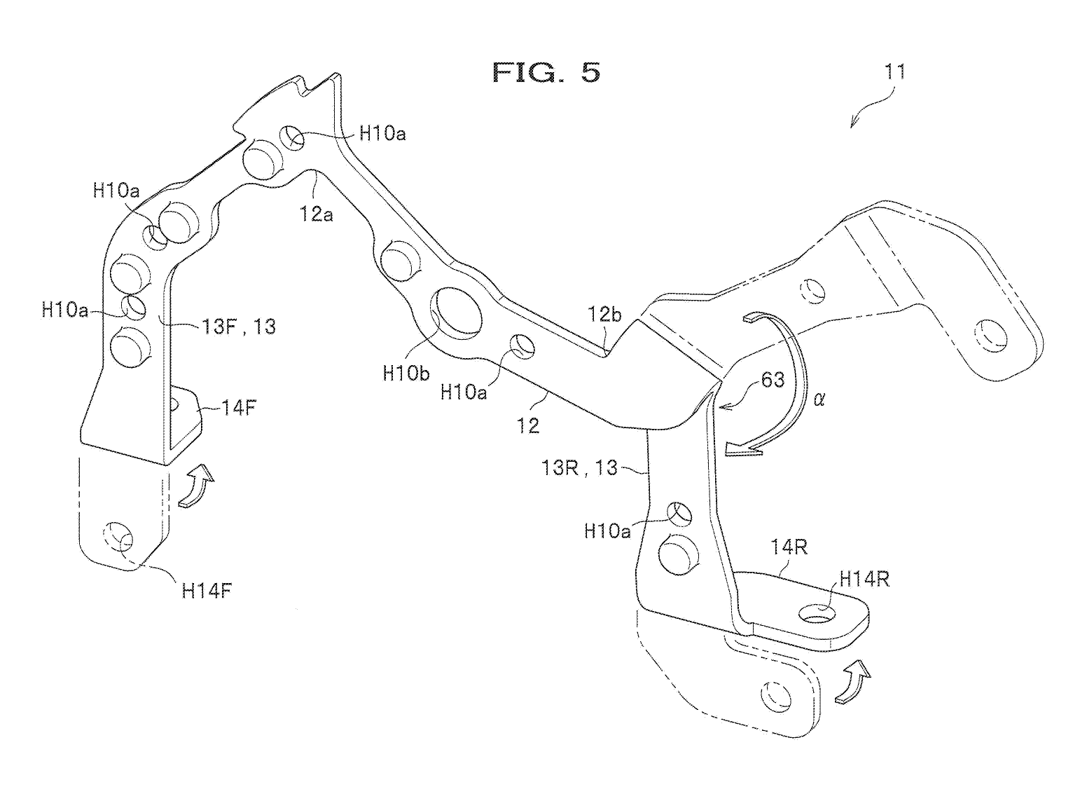

As shown in FIG. 5, the rear-side leg portion 13R before folding is a portion that supports a rear side of the structural main body 12 onto the vehicle body and before folding extends upwardly from a rear upper edge 12b of the structural main body 12 (also see FIG. 4).

That is, the rear-side leg portion 13R extends such that as the distance from the structural main body 12 increases, the distance from the front-side leg portion 13F increases.

On the other hand, after folding, as shown in FIGS. 3 and 5, the rear-side leg portion 13R is folded 180 degrees over the plate surface of the structural main body 12. This makes a cross section of the structural material 11 look like a substantial U-shape formed by the rear-side leg portion 13R (U-shape viewed in an extending direction of the structural main body 12) and the structural main body 12 (see FIG. 3).

Here, the rear-side leg portion 13R is folded 180 degrees over the plate surface of the structural main body 12 and extends downwardly from the structural main body 12. In this way, the rear-side leg portion 13R functions as a leg portion that supports the structural main body 12.

More specifically, the rear upper edge 12b is continuous with the rear-side leg portion 13R via a folded region 61 to have a bending angle of 180 degrees between an inner surface 12d of the structural main body 12 and an inner surface 13d of the leg portions 13 at overlapping portions of the structural main body structural main body 12 and the rear-side leg portion 13R. In other words, the inner surface 12d of the structural main body and the inner surface 13d of the rear-side leg portion 13R are in parallel with each other and the folded region 61 has a halfpipe shape.

Note that in FIG. 3, the case is omitted so as to facilitate understanding of the configuration of the structural material 11.

The rear-side leg portion 13R has, as a vehicle body fixture, a rear-side fixing piece 14R on the end portion thereof.

The rear-side fixing piece 14R is bent toward the vehicle width direction such that a plate surface of the rear-side leg portion 13R is in contact with the upper surface of the floor tunnel while the rear-side leg portion 13R is folded 180 degrees like a substantial U-shape. Also, the rear-side fixing piece 14R has a rear-side fixing hole H14R.

A bolt 51, a fastening means, is inserted through the rear-side fixing hole H14R and a nut 52 is screwed on the bolt 51. In this way, the rear-side leg portion 13R is fixed to the vehicle body (see FIG. 3).

That is, in other words, regarding the pair of leg portions 13 (the front-side leg portion 13F and the rear-side leg portion 13R) before the rear-side leg portion 13R is folded, one of the portions extends such that as the distance from the structural main body 12 increases, the distance between the one portion and the other portion increases.

Next, the case 15 is explained below.

The case 15 is made of a pair of case members 16 that are left and right split parts arranged face-to-face. Meanwhile, the pair of case members 16 are each composed of flat plate materials, and each case member includes a case main body 17 and a case fixing piece 18.

The case main body 17 has an edge wall 19 facing a partner case member 16.

The case 15 is formed of an outer shell having an inside housing space while the paired case members 16 are arranged face-to-face. Then, the housing space formed houses the structural material 11.

There are a plurality of base connecting holes H10a facing through holes of 3 members: the structural main body 12 and the pair of case members 16.

A cylindrical rivet collar 40 is inserted into each base connecting hole H10a. Then, a rim of the rivet collar 40 is extended and eyeletted, so that the rivet collar 40 is used to position the structural main body 12 and the pair of case members 16, which are integrally fixed.

Next, the parking lever 20 is explained.

The parking lever 20 is arranged in the vehicle longitudinal direction. A rear-end side thereof is supported onto the base 10 by using the support shaft 21. In addition, a front-end side of the parking lever 20 has a grip portion 22 that a driver holds at the time of braking operation.

The grip portion 22 can keep the parking brake device 1 in a braking state when the grip portion 22 is positioned at a braking position that is set to an upper position in a movable range. In addition, the grip portion 22 causes the parking brake device 1 to release braking when the grip portion 22 is positioned at a braking release position that is set to a lower position in the movable range.

Next, the ratchet mechanism 30 is explained below.

The ratchet mechanism 30 is installed between the structural main body 12 and the parking lever 20. When lifted, the parking lever 20 is moved to the braking position. The ratchet mechanism 30 can keep the parking lever 20 at the braking position. Also, when a lock is disengaged by pressing a release button 33, the parking lever 20 can be moved from the braking position to the braking release position. Such a ratchet mechanism 30 includes a ratchet gear 31 and a ratchet pawl 32.

The ratchet gear 31 is disposed at a front-end portion of the structural main body 12 and disposed upwardly of the front-side leg portion 13F. The ratchet gear 31 includes a plurality of gear teeth arranged continuously on an arc where the support hole H10b is located at its center.

The ratchet pawl 32 is attached to the parking lever 20. The ratchet pawl 32 is biased, using a biasing device such as a spring (not shown), toward the addendum of the ratchet gear 31 (from the gear disengagement side to the gear engagement side).

During movement from the braking release position side to the braking position side, the ratchet pawl 32 is not engaged with the ratchet gear 31 but moves while touching the addendum of the ratchet gear 31. This enables the parking lever 20 to move to the braking position when lifted.

During movement from the braking position side to the braking release position side, the ratchet pawl 32 remains engaged with the ratchet gear 31 due to biasing force generated by a biasing device (not shown), so that the movement of the ratchet pawl 32 is restricted. This can keep the parking lever 20 at the braking position.

The release button 33 may be pushed against the biasing force generated by the biasing device (not shown) while the ratchet pawl 32 is engaged with the ratchet gear 31. In this case, the ratchet pawl 32 rotates and detaches from the ratchet gear 31, so that the gear is disengaged. In this way, the parking lever 20 can be moved from the braking position side to the braking release position side.

The following describes advantageous effects of this parking brake device 1.

In this embodiment, the rear-side leg portion 13R, one of the leg portions 13, is folded 180 degrees over and faces a plate surface of the structural main body 12.

Such a configuration makes it possible to produce a structural material 11 with a good manufacturing yield without any splitting that can cause a decrease in rigidity. That is, it is possible to produce a base 10 having both a good manufacturing yield and high rigidity.

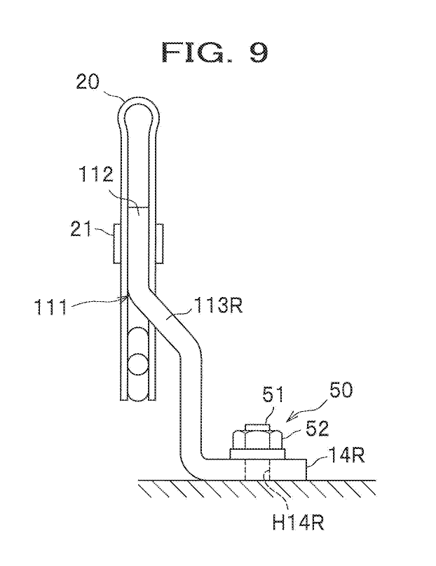

FIG. 9 shows a comparative example considered by the inventor for easy explanation of an advantageous effect. In the structure of the base according a comparative example considered by the inventor shown in FIG. 9, the steps of manufacturing a structural material 111 of the comparative example with a low manufacturing yield include a step of creating a necessary space between a main body 112 and a rear-side leg portion 113R after the structural material 111 has been punched out from a parent material. Instead of such a processing step, this embodiment includes a step of causing a structural material to be folded 180 degrees (greater than 90 degrees) face-to-face.

That is, the configuration of this embodiment has a less number of processing steps than that for the structural material 111 according to the comparative example.

In this embodiment, the rear-side leg portion 13R is folded 180 degrees over and faces a plate surface of the structural main body 12. This makes a cross section of the structural material 11 look like a substantial U-shape formed by the rear-side leg portion 13R and the structural main body 12.

Such a configuration can minimize the distance between the structural main body 12 and the rear-side leg portion 13R while realizing a minimum size.

This permits the rear-side leg portion 13R to be shorter, thereby capable of making a parent material B, from which the structural material 11 is punched out, a smaller plate material and making the outer size of the base 10 smaller.

In addition, in this embodiment, regarding the pair of leg portions 13 (the front-side leg portion 13F and the rear-side leg portion 13R) before the rear-side leg portion is folded, one of the portions extends such that as the distance from the structural main body 12 increases, the distance between the one portion and the other portion increases.

As shown in FIG. 4, this enables a manufacturing yield to further increase because the gap between the structural materials 11 can be made narrower when the structural materials 11 are punched out from the parent material B.

Note that although this embodiment is provided with one front-side leg portion 13 and one rear-side leg portion 13, the present invention is not limited to such a configuration.

For instance, it is possible to configure such that another leg portion positioned forwardly of the support hole H10b is added to the structural main body 12 and the leg portion is folded 180 degrees over the plate surface. This can achieve substantially the same advantageous effects as of this embodiment.

The following describes another embodiment, namely a first embodiment of the structural material 11.

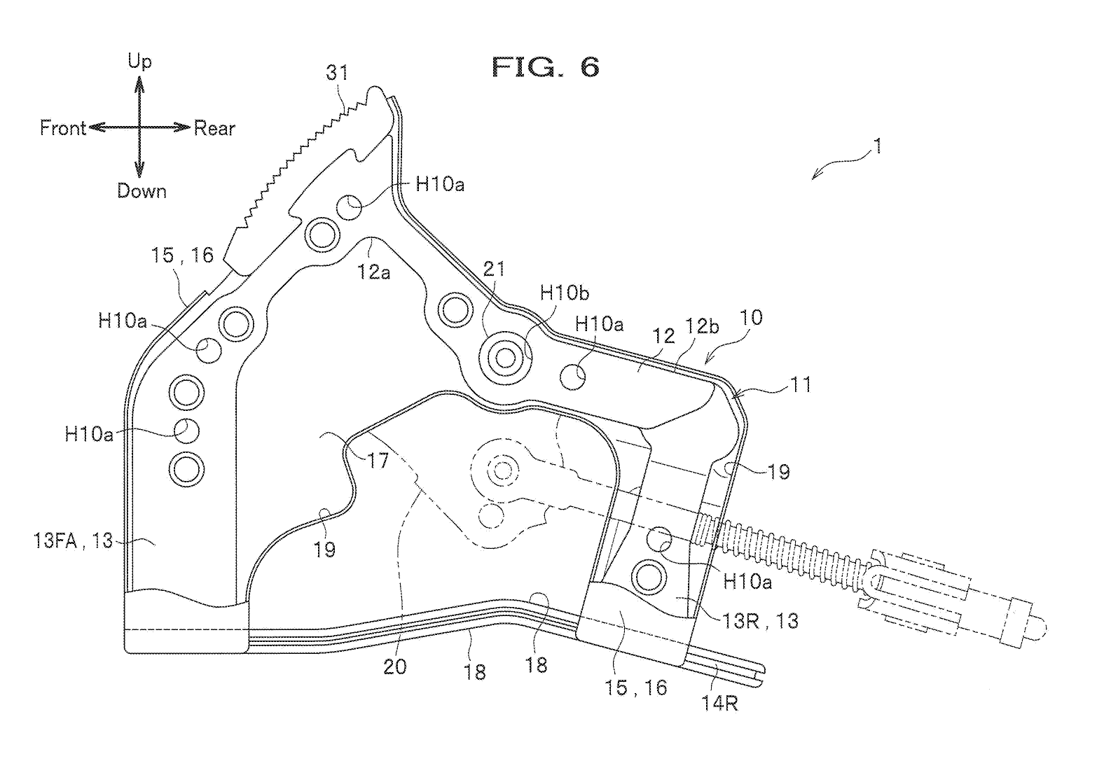

As shown in FIG. 6, a big difference between the structural material 11 of the above embodiment and that of the first embodiment involves the structure of a front-side leg portion 13FA.

The width of the front-side leg portion 13FA of the first embodiment is broader than that of the front-side leg portion 13F of the above embodiment.

Such a configuration enables the rigidity of the front-side leg portion 13FA to increase, thereby increasing the rigidity of the whole base 10.

The following describes another embodiment, namely a second embodiment of the structural material 11.

The above embodiment makes a cross section of the structural material 11 look like a substantial U-shape formed by the rear-side leg portion 13R and the structural main body 12. The present invention, however, is not limited to such a shape.

For instance, as shown in FIG. 7, it is also possible to make the cross section look like a substantial big U-shape formed by a rear-side leg portion 13RB and the structural main body 12. Such a shape can also achieve substantially the same advantageous effects as of the above embodiment. Besides, such a shape is more preferable when a fastener point 50 (rear-side fixing hole H14R) is desirably provided with a spacing L from the plate surface of the structural main body 12 in the vehicle width direction.

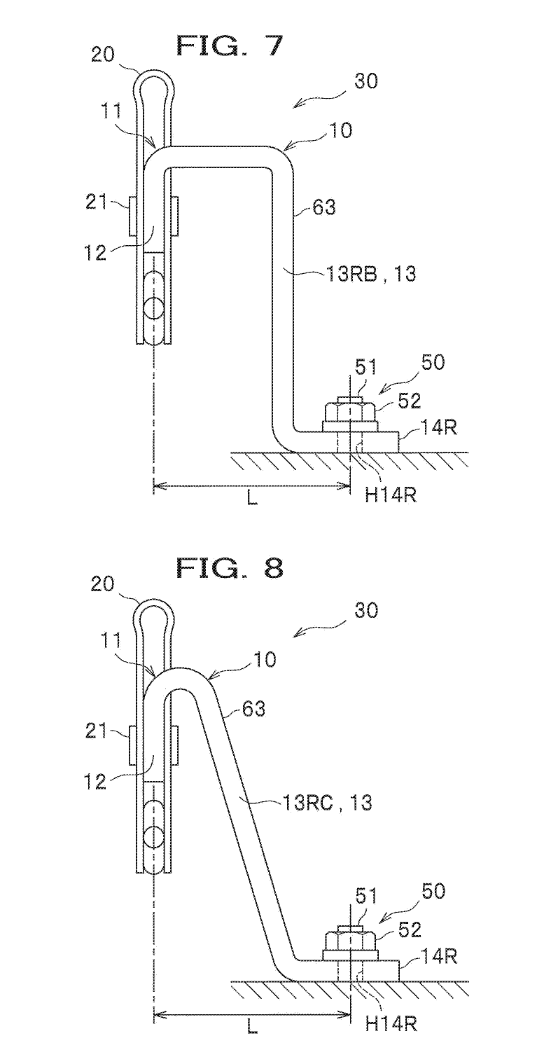

Further, as shown in FIG. 8, it is also possible to make the cross section look like a substantial V-shape by causing a rear-side leg portion 13RC to be folded about 150 degrees toward and face the plate surface of the structural main body 12 (a third embodiment). Such a shape can also achieve substantially the same advantageous effects as of the above embodiment. In addition, such a shape is further preferable because a weight increase is suppressed more than that for the shape where the rear-side leg portion is folded like a big U-shape.

More specifically, as shown in FIGS. 3 and 5, the rear-side leg portion 13R is preferably folded 180 degrees over the plate surface of the structural main body 12. However, the rear-side leg portion 13R can be folded by a predetermined angle of from 90 degrees to 200 degrees over the plate surface of the structural main body 12. Folding this region increases a strength at this region of the structural main body 12.

Note that this parking brake device 1 is installed, as a braking unit, on a floor tunnel (not shown) positioned between a driver's seat and a passenger seat. The present invention is not limited to such a form.

For instance, it is applicable for a base that is installed, beside a steering wheel (not shown), as a part of a braking unit pulled by a driver. Such an application can also exert substantially the same advantageous effects.

As described above, according to the present invention, there is provided a parking brake device 1 including:

a structural material (structural plate material) 11 including:
a structural main body 12 that swingably supports a parking lever 20; and
a plurality of leg portions 13 that continuously extend from the structural main body 12, an extending end of each leg portion being fixed to a vehicle body 60.

At least one of the leg portions includes a folded region 61 and a folded over region 63 that faces the structural main body 12.

The at least one of the leg portions 13 is integral with (continuous from) the structural main body 12. This is because as shown in FIG. 5, this configuration is made by folding the structural material 11 by 180 degrees over the plate surface of the structural main body 12 to have the rear-side leg portion 13R.

In addition, as shown in FIG. 5, the front-side leg portion 13F is integral (continuous) with the structural main body 12. In other words, the structural main body 12 and a plurality of the leg portions 13 are integral (continuous) with each other.

1. A parking brake device comprising:
a structural material including:
a structural main body that supports a parking lever; and
a plurality of leg portions that extend from the structural main body, an end of each leg portion being fixed to a vehicle body,
wherein at least one of the leg portions includes a folded region and a folded over region that faces the structural main body.

2. The parking brake device as claimed in claim 1, wherein the folded region makes an angle more than 90 degree and not larger than 200 degrees between surfaces of the structural main body and the folded over region.

3. The parking brake device according to claim 1, wherein the structural material has a substantial U-shape formed by the structural main body and the at least one leg portion.

4. The parking brake device according to claim 1, wherein the at least one of the leg portions is integral with the structural main body.

5. The parking brake device as claimed in claim 1, wherein the structural main body and a plurality of the leg portions are integral.

6. The parking brake device according to claim 2, wherein the angle is 180 degrees.
